(19) United States
(12) Patent Application Publication
(10) Pub. No.: US 2012/0163336 A1
(43) Pub. Date: Jun. 28, 2012

(54) DISTRIBUTED ARCHITECTURE FOR SECURITY KEYS DERIVATION IN SUPPORT OF NON-INVOLVED CORE NETWORK HANDOVER

(75) Inventors: Pascal M. Adjakple, Great Neck, NY (US); Mahmoud Watfa, Saint Leonard (CA); Ulises Olvera-Hernandez, Kirkland (CA); Virgil Comsa, Montreal (CA); Catalina M. Mladin, Hatboro, PA (US)

(73) Assignee: InterDigital Patent Holdings, Inc., Wilmington (DE)

(21) Appl. No.: 13/163,545

(22) Filed: Jun. 17, 2011

Related U.S. Application Data
(60) Provisional application No. 61/356,387, filed on Jun. 18, 2010.

(51) Int. Cl. H04W 36/24

(52) U.S. Cl. 370/331

(57) ABSTRACT

Methods and systems are disclosed for an evolved node-B (eNB), or home evolved node-B (HeNB), which may be a part of a communication network. The eNB or HeNB may receive a first information regarding a handover from another node of the communication network and calculate a second information based on the first information. The eNB or HeNB may provide handover information based on the second information to a node designated to receive the handover.

### CROSS REFERENCE TO RELATED APPLICATIONS

This application claims the benefit of U.S. provisional application No. 61/356,387, titled “Home Evolved Node B Mobility Enhancements in LTE”, filed on Jun. 18, 2010, the content of which is hereby incorporated by reference herein, for all purposes.

### BACKGROUND

The transfer, or “handover”, of user equipment (UE) devices, such as mobile devices like cell phones, for example, from one Home evolved Node-B (HeNB) or an evolved Node-B (eNB) to another HeNB or eNB in a communications network may place burdens on one or more core network elements. One such network element that may be burdened is the Mobility Management Entity (MME).

Due to network activity, such as access control or membership verification requirements, among other activity, the MME may often, or perhaps always, be involved in the handover (HO) of the UE. For example, in a campus scenario where many HeNBs may be deployed, the signaling due to handovers of UEs across HeNBs or eNBs may overload the MME. Other communications network activity may also place burdens on the MME, such as a handover of one or more UEs from an eNB to another eNB or from an eNB to an HeNB, and the like.

### SUMMARY

This Summary is provided to introduce a selection of concepts in a simplified form that are further described below the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

Embodiments contemplate mobility enhancements such as the option to terminate the handover at an HeNB Gateway (GW) or at a GW (local GW or LGW) that may be located in the same local network as the HeNB. Alternatively or additionally, embodiments contemplate the introduction of an X2 interface between HeNBs, between one or more HeNBs and one or more eNBs, and/or between one or more HeNBs and one or more HeNB GW.

Embodiments also contemplate handling of security parameters during a transparent (e.g., core network not involved) HeNB-HeNB mobility handover. A network GW may calculate new security parameters thereby replicating MME functionality. A network GW in coordination with the MME (or any other network entity or node that may function in a role similar to the one of MME) may calculate new security parameters.

Embodiments also contemplate handling MME initiated signaling during an ongoing transparent handover.

Embodiments also contemplate one or more architectures for connecting network components such as eNBs, HeNBs, and the GW to accommodate transparent handovers.

Embodiments also contemplate handling one or more handovers for which a target HeNB may not support some or all Radio Access Bearers (RABs), from the source HeNB.

Contemplated embodiments may be performed by a first node, where the first node may be in communication with a communication network. Embodiments contemplate receiving a first information from a second node. Embodiments contemplate that the second node may be in communication with the communication network. Embodiments contemplate determining a second information based, at least in part, on the first information. And embodiments contemplate determining handover information based, at least in part, on the second information. Embodiments further contemplate that the first information may be at least one of a next hop (NH) parameter or Next hop Chaining Counter (NCC) parameter and that the second node may be a home evolved node-B gateway (HeNB-GW). Also, contemplated embodiments may include providing the handover information to a third node.

Embodiments contemplate that the third node may be in communication with the communication network and that the third node may be at least one of a home evolved node-B gateway (HeNB-GW), an evolved node-B (eNB), a home evolved node-B (HeNB), or a user equipment (UE). Alternatively or additionally, embodiments contemplate that the first node may be designated to receive the handover and the first node may be at least one of an evolved node-B (eNB) or a home evolved node-B (HeNB). Also, embodiments contemplate that the second information may be a K_{eNB}, and that, alternatively or additionally, the second information may be derived, at least in part, by vertical key derivation. Embodiments also contemplate that that the handover information may include at least one of a K_{eNB} or the Next hop Chaining Counter (NCC) parameter. In addition, embodiments contemplate that the first information may be received via at least one of an X2 interface or an S1 interface.

Contemplated embodiments may be performed by a first node, where the first node may be in communication with a communication network. Embodiments contemplate receiving a first information from a second node, where the second node may be in communication with the communication network. Embodiments further contemplate determining handover information based, at least in part, on the first information, and providing the handover information to the second node. Embodiments contemplate sending a message to a third node, and, receiving a second information from the third node in response to the message.

Embodiments contemplate that the first node may be designated to receive the handover and that the first node may be at least one of an evolved node-B (eNB) or a home evolved node-B (HeNB). Alternatively or additionally, embodiments contemplate that the second node may be designated to initiate the handover and that the second node may be at least one of an evolved node-B (eNB) or a home evolved node-B (HeNB). Embodiments also contemplate that the first information may be received via an X2 interface and/or the handover information may be provided via the X2 interface. Alternatively or additionally, the third node may be a home evolved Node-B gateway (HeNB-GW), and/or the first node may be at least one of an evolved node-B (eNB) or a home evolved node-B (HeNB).

Embodiments also contemplate one or more devices, or nodes, such as but not limited to a home evolved node-B gateway (HeNB-GW), an evolved node-B (eNB), a home evolved node-B (HeNB), or a user equipment (UE), that may be configured to perform the described embodiments.

### BRIEF DESCRIPTION OF THE DRAWINGS

A more detailed understanding may be obtained from the following description, given by way of example in conjunction with the accompanying drawings wherein:

FIG. 1A is a system diagram of an example communications system in which one or more disclosed embodiments may be implemented;

FIG. 1B is a system diagram of an example wireless transmit/receive unit (WTRU) that may be used within the communications system illustrated in FIG. 1A;

FIG. 1C is a system diagram of an example radio access network and an example core network that may be used within the communications system illustrated in FIG. 1A;

FIG. 1D illustrates a communication network architecture in which UE handovers terminate at a mobility management entity consistent with embodiments;

FIG. 2 illustrates a communication network architecture in which UE handovers terminate at an evolved node-B consistent with embodiments;

FIG. 3 illustrates another communication network architecture in which UE handovers terminate at an evolved node-B consistent with embodiments;

FIG. 4 illustrates another communication network architecture in which UE handovers terminate at an evolved node-B consistent with embodiments;

FIG. 4A illustrates an exemplary signal flow of a handover consistent with embodiments;

FIG. 4B illustrates a continuation of the exemplary signal flow depicted in FIG. 4A;

FIG. 4C illustrates another exemplary signal flow of a handover consistent with embodiments;

FIG. 4D illustrates a continuation of the embodiment depicted in FIG. 4C;

FIG. 5 illustrates another communication network architecture in which UE handovers terminate at an evolved node-B consistent with embodiments;

FIG. 6 illustrates a flowchart of an exemplary node mobility embodiment;

FIG. 7 illustrates a flowchart of another exemplary node mobility embodiment; and

FIG. 8 illustrates a flowchart of another exemplary node mobility embodiment.

### DETAILED DESCRIPTION OF ILLUSTRATIVE EMBODIMENTS

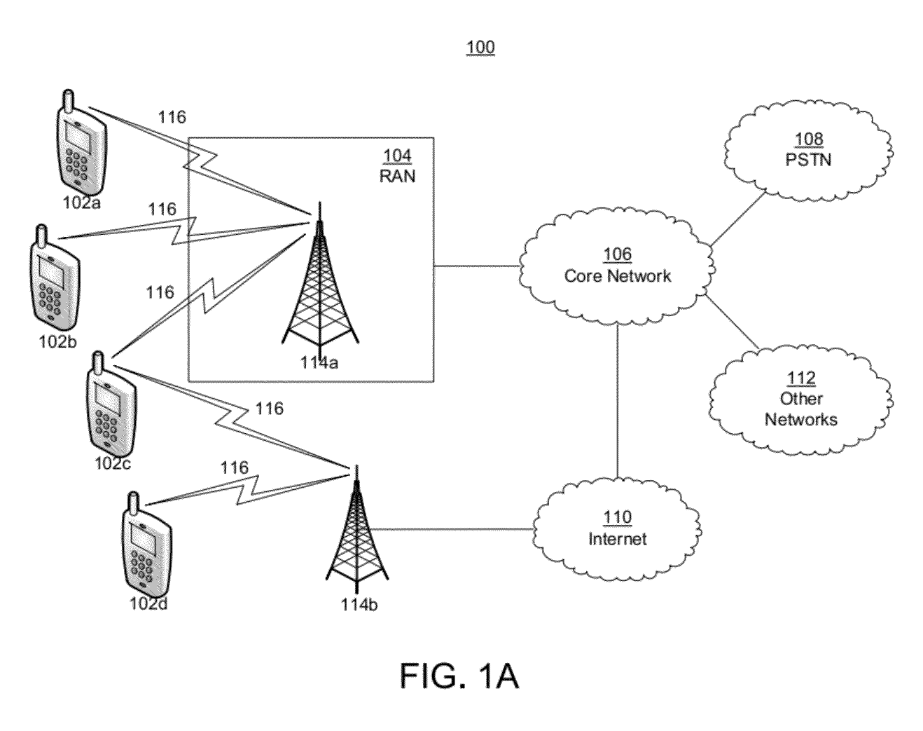

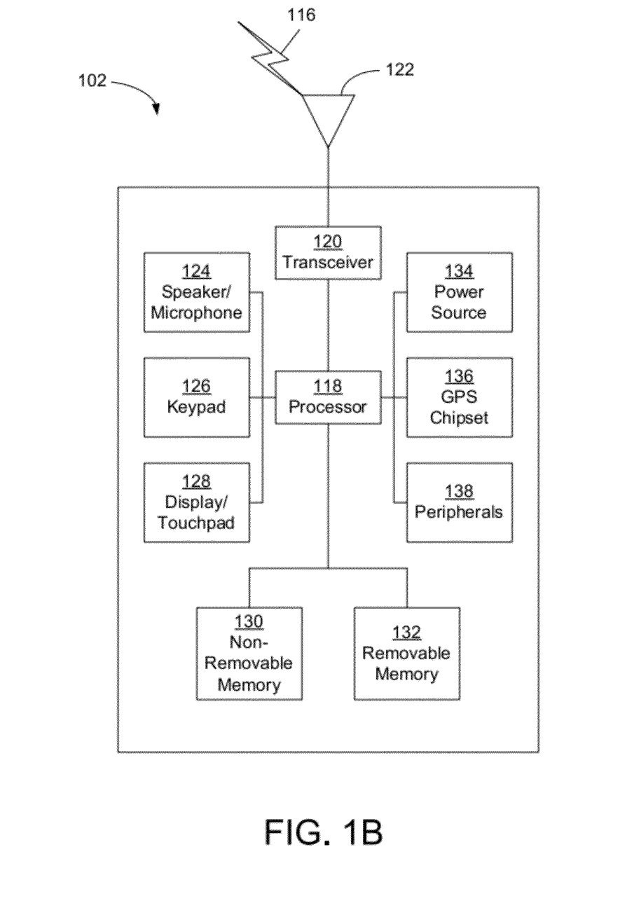

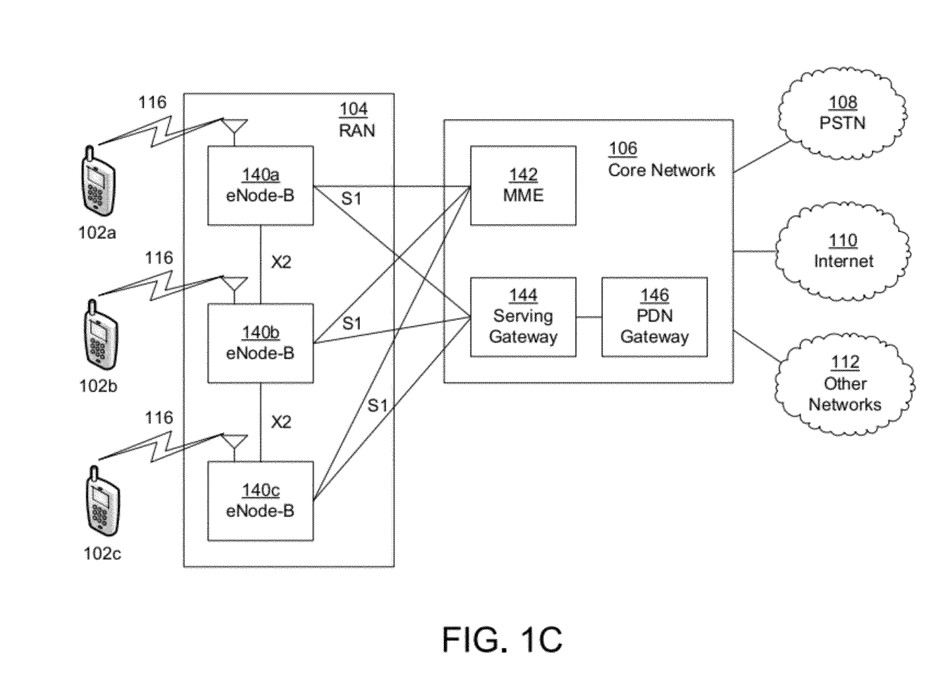

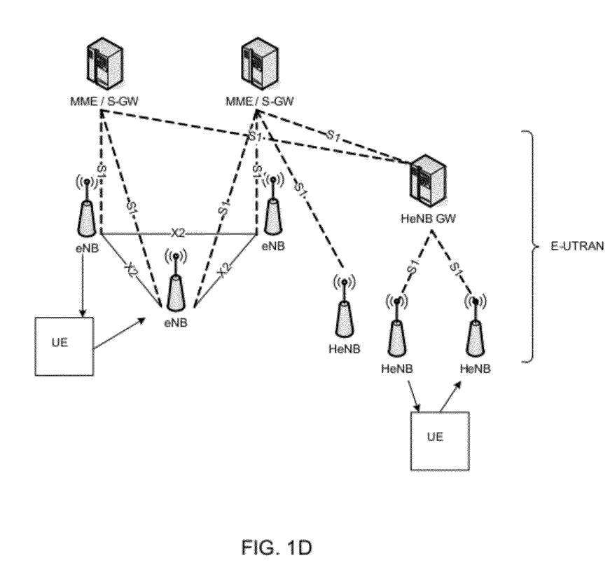

A detailed description of illustrative embodiments will now be described with reference to FIGS. 1A-8. Although this description provides a detailed example of possible embodiments, it should be noted that the details are intended to be exemplary and in no way limit the scope of disclosed embodiments.

In the description, user equipment (UE) may include various wireless transmit/receive units, such as cell phone and other mobile devices. Also, a core communications network or core network (CN) may be used to refer to all or several nodes in the CN. Moreover, some embodiments contemplate that the CN may also be used to refer to the MME alone.

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the networks 112. By way of example, the base stations 114a, 114b may be a base transceiver station (BTS), a Node-B, an eNode-B, a Home Node-B, a Home eNode-B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link (e.g., radio frequency (RF), microwave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA20001x, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over internet protocol (VoIP) services to one or more of the WTRUs 102a, 102b, 102c, 102d. For example, the core network 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an embodiment. Further, the base stations 114a and/or 114b may include some or all of the components depicted in FIG. 1B and described herein.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 104 and the core network 106 according to an embodiment. As noted above, the RAN 104 may employ an E-UTRA radio technology to communicate with the WTRUs 102a, 102b, 102c over the air interface 116. The RAN 104 may also be in communication with the core network 106.

The RAN 104 may include eNode-Bs 140a, 140b, 140c, though it will be appreciated that the RAN 104 may include any number of eNode-Bs while remaining consistent with an embodiment. The eNode-Bs 140a, 140b, 140c may each include one or more transceivers for communicating with the WTRUs 102a, 102b, 102c over the air interface 116. In one embodiment, the eNode-Bs 140a, 140b, 140c may implement MIMO technology. Thus, the eNode-B 140a, for example, may use multiple antennas to transmit wireless signals to, and receive wireless signals from, the WTRU 102a.

Each of the eNode-Bs 140a, 140b, 140c may be associated with a particular cell (not shown) and may be configured to handle radio resource management decisions, handover decisions, scheduling of users in the uplink and/or downlink, and the like. As shown in FIG. 1C, the eNode-Bs 140a, 140b, 140c may communicate with one another over an X2 interface.

The core network 106 shown in FIG. 1C may include a mobility management gateway (MME) 142, a serving gateway 144, and a packet data network (PDN) gateway 146. While each of the foregoing elements are depicted as part of the core network 106, it will be appreciated that any one of these elements may be owned and/or operated by an entity other than the core network operator.

The MME 142 may be connected to each of the eNode-Bs 142a, 142b, 142c in the RAN 104 via an S1 interface and may serve as a control node. For example, the MME 142 may be responsible for authenticating users of the WTRUs 102a, 102b, 102c, bearer activation/deactivation, selecting a particular serving gateway during an initial attach of the WTRUs 102a, 102b, 102c, and the like. The MME 142 may also provide a control plane function for switching between the RAN 104 and other RANs (not shown) that employ other radio technologies, such as GSM or WCDMA.

The serving gateway 144 may be connected to each of the eNode-Bs 140a, 140b, 140c in the RAN 104 via the S1 interface. The serving gateway 144 may generally route and forward user data packets to/from the WTRUs 102a, 102b, 102c. The serving gateway 144 may also perform other functions, such as anchoring user planes during inter-eNode-B handovers, triggering paging when downlink data is available for the WTRUs 102a, 102b, 102c, managing and storing contexts of the WTRUs 102a, 102b, 102c, and the like.

The serving gateway 144 may also be connected to the PDN gateway 146, which may provide the WTRUs 102a, 102b, 102c with access to packet-switched networks, such as the Internet 110, to facilitate communications between the WTRUs 102a, 102b, 102c and IP-enabled devices.

The core network 106 may facilitate communications with other networks. For example, the core network 106 may provide the WTRUs 102a, 102b, 102c with access to circuit-switched networks, such as the PSTN 108, to facilitate communications between the WTRUs 102a, 102b, 102c and traditional land-line communications devices. For example, the core network 106 may include, or may communicate with, an IP gateway (e.g., an IP multimedia subsystem (IMS) server) that serves as an interface between the core network 106 and the PSTN 108. In addition, the core network 106 may provide the WTRUs 102a, 102b, 102c with access to the networks 112, which may include other wired or wireless networks that are owned and/or operated by other service providers.

As seen in FIG. 1D, in an exemplary network contemplated by embodiments, the MME may be involved, and in some embodiments perhaps heavily involved, in the transfer of a UE among eNBs and/or among HeNBs. Embodiments contemplate that for different reasons and under various circumstances, the X2 interface may not be available between HeNBs or eNBs. When the X2 interface may not be available during handovers, embodiments contemplate that signaling may be done via the S1 interface, for example. An X2 interface may be considered a logical interface between two eNBs, e.g., from a logical standpoint. Also, the X2 may be a point-to-point interface between two eNBs within the Evolved Universal Terrestrial Radio Access Network (E-UTRAN). An X2 point-to-point logical interface may be feasible even in the absence of a physical direct connection between the two eNBs (or between an eNB and an HeNB or between two HeNBs, etc.). In this way, an X2 interface may be viewed as an intra-E-UTRAN interface. Embodiments contemplate that an S1 interface may be a logical interface between an eNB and the core network (CN). For example, from a logical standpoint, the S1 may be a point-to-point interface between an eNB within the E-UTRAN and an MME in the EPC (Evolved Packet Core network). A point-to-point S1 logical interface may be feasible and/or effected even in the absence of a physical direct connection between the eNB and MME.

Embodiments contemplate mobility enhancements for HeNB for LTE releases at, and beyond, Release 9. Embodiments also contemplate one or more techniques to address security issues may be encountered when the role of the MME may be limited in handovers, such as, for example, when the X2 interface may be used and/or the handover procedure may not be terminated at the MME.

Embodiments contemplate that to make a handover (HO) transparent to the CN and/or to at least place less of a burden on the CN, several issues may need to be considered to ensure smooth operation. One such issue is that the CN may, perhaps too suddenly, realize that a particular UE that once was in a source node (HeNB or eNB) may now be connected to another node (HeNB or eNB). Another issue the embodiments contemplate may be the security associated with the handover (HO).

With regards to security, even though the access stratum keys may be exchanged between a source HeNB and a target HeNB during HO, the MME may still need to take some actions with regards to the security context. Embodiments contemplate that for a current S1 or X2 HO, the MME at some point during the signaling may be informed about the HO and may update some parameters of the security context. For example, after an X2 HO is completed, the MME may receive an S1 PATH SWITCH REQUEST, and the MME may increase the Next hop Chaining Counter (NCC) value and may compute a new Next Hop (NH) parameter. A new {NH, NCC} pair may be sent to a target eNB via a S1 PATH SWITCH REQUEST ACKNOWLEDGE message. Similar behavior may be performed by the MME for an S1 HO, e.g., the MME may compute a new {NH, NCC} pair that may be forwarded to the target eNB.

Embodiments contemplate the concept of forward security. Forward security may refer to the property that for an eNB with knowledge of a key K_{eNB}, shared with a UE, predicting one or more, or perhaps any, future K_{eNB} that may be used between the same UE and another eNB may be computationally infeasible. A horizontal key derivation may be described as a target K_{eNB} (referred to as K_{eNB*}) that may be derived from the current K_{eNB}. Alternatively or additionally, a vertical key derivation may be described as the K_{eNB*} that may be derived from the NH parameter (which may be previously unused by the source eNB). For both types of derivations, the physical cell identity (PCI) and the frequency (EARFCN-DL) of the target eNB may also be used for the derivation of the K_{eNB*}.

Embodiments contemplate that an n hop forward security may refer to the property that an eNB may be unable (perhaps due to computational infeasibility) to compute keys that may be used between a UE and another eNB to which the UE may be connected after n or more handovers (where n may=2, for example). For example, two consecutive horizontal key derivations may not be performed since the first eNB may be able to guess the K_{eNB} that may be used between a third eNB and the UE. Therefore, a vertical key derivation may be performed between the first and the second HO so that the keys may not be predicted.

As the NH (Next Hop) parameter may only be computed by the UE and the MME, it may be arranged so that the NH parameter (and the associated NCC—i.e. Next hop Chaining Counter) may be provided to eNBs from the MME in such a way that forward security can be achieved. A partially transparent X2 handover or S1 handover to the MME, and in some embodiments a fully transparent X2 handover or S1 handover to the MME, may imply that the only key chaining (or key derivation) scheme available at handover is the horizontal key derivation. Embodiments contemplate that using horizontal key derivation as the sole key chaining scheme during two or more handovers may compromise the forward security principle/requirement in comparison to how forward security should be handled in release 8/9 of LTE.

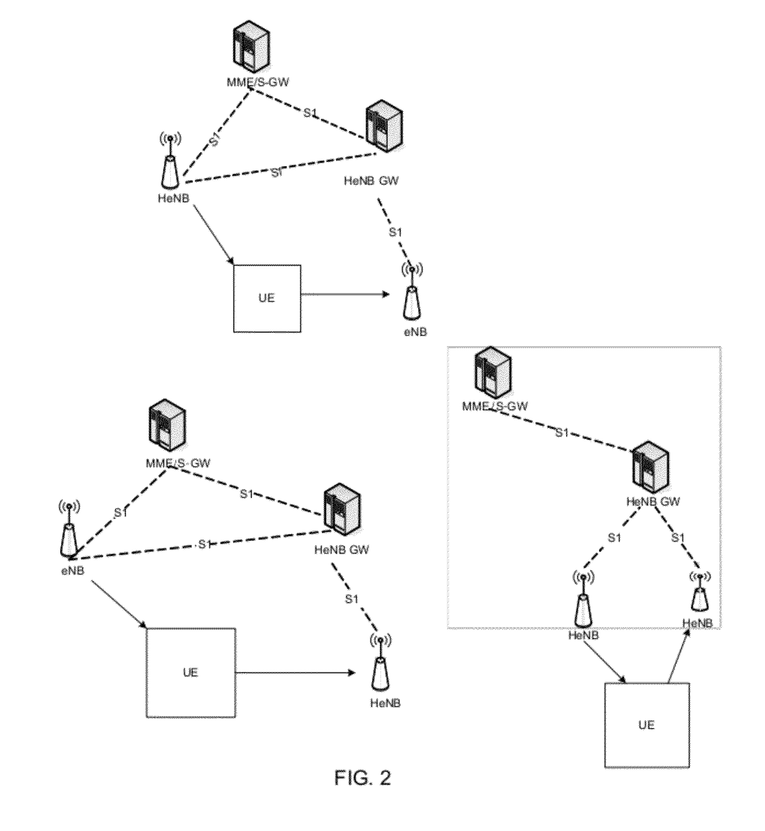

FIG. 2 illustrates a scenario where the HO procedure may be terminated at the HeNB-GW using an S1 interface. Embodiments contemplate that, at an initial context establishment or context modification, the MME may provide the HeNB-GW with the security context including an initial K_{eNB}, the corresponding derived NH value, and/or the associated NCC parameter (e.g., value one). An S1-AP message that may be used for initial context establishment is the INITIAL CONTEXT SETUP REQUEST message, for example. An example of an S1-AP message used for the UE context modification is the CONTEXT MODIFICATION REQUEST message. An HeNB-GW may use the security information provided by the MME, including the (NH, NCC), pair to initialize the NH derivation chain. Alternatively or additionally, embodiments contemplate that the HeNB-GW may initialize the security keys derivation process (e.g., compute initial KeNB and set NCC to 0). The HeNB-GW can do this on its own, in coordination with MME, or in coordination with other core network nodes such as the HSS (Home Subscriber Server), for example.

At handover (HO), e.g., upon receiving S1-AP HANDOVER REQUIRED message from the source eNB or HeNB, the HeNB-GW may generate a fresh (NH, NCC) pair and may provide this pair to the target eNB or HeNB in an S1-AP HANDOVER REQUEST message. Upon receipt of the S1-AP HANDOVER REQUEST message from the HeNB-GW, the target eNB or HeNB may compute the K_{eNB} to be used with the UE by performing a vertical key derivation using the fresh (NH, NCC) pair in the S1-AP HANDOVER REQUEST, the target PCI, and/or the target eNB's or target HeNB's Evolved Universal Terrestrial Radio Access (E-UTRA) Absolute Radio Frequency Channel Number on Down Link (EARFCN-DL) The target eNB or HeNB may associate the NCC value received from HeNB-GW with the K_{eNB}. The target eNB or HeNB may include the NCC value from the received (NH, NCC) pair into the HO Command to the UE (perhaps via the HeNB-GW and/or the source eNB or HeNB), perhaps via an S1 interface and, alternatively or additionally, may remove any existing unused stored (NH, NCC) pairs.

Embodiments contemplate that the KeNB may not be included in the HO command. As described previously, embodiments contemplate that the NCC parameter may be included in the HO command and that the NCC parameter may be used by the UE to ensure that the KeNB that may be independently computed at the UE is same as the one being used at the eNB or the HeNB. This is the case for one or more of the embodiments described herein. Other security information that may be included in the handover command include but is not limited to the securityAlgorithmConfig IE, the keyChangeIndicator parameter IE (of type Boolean), and the nas-SecurityParamToEUTRA IE (in the case of interRAT handover, for example).

Embodiments further contemplate that the keyChangeIndicator set to “true” may be used in an intra-cell handover, and in some embodiments perhaps may only be used in an intra-cell handover, when a KeNB key is derived from a native K_{ASME} key taken into use through the successful NAS Security Mode Command (SMC). Embodiments contemplate that the keyChangeIndicator set to ‘false’ may be used in an intra-LTE handover when the new K_{eNB} key is obtained from the current KeNB key or from the NH. The IE SecurityAlgorithmConfig may be used to configure AS integrity protection algorithm (SRBs) and AS ciphering algorithm (SRBs and DRBs). The nas-SecurityParamToEUTRA IE may be used to transfer UE specific NAS layer information between the network and the UE. The RRC layer may be transparent for this field, although the RRC layer may affect activation of AS—security after inter-RAT handover to E-UTRA. Embodiments also contemplate that the HeNB-GW may take the role of the MME with regards to computing new NH and NCC pair values during HO.

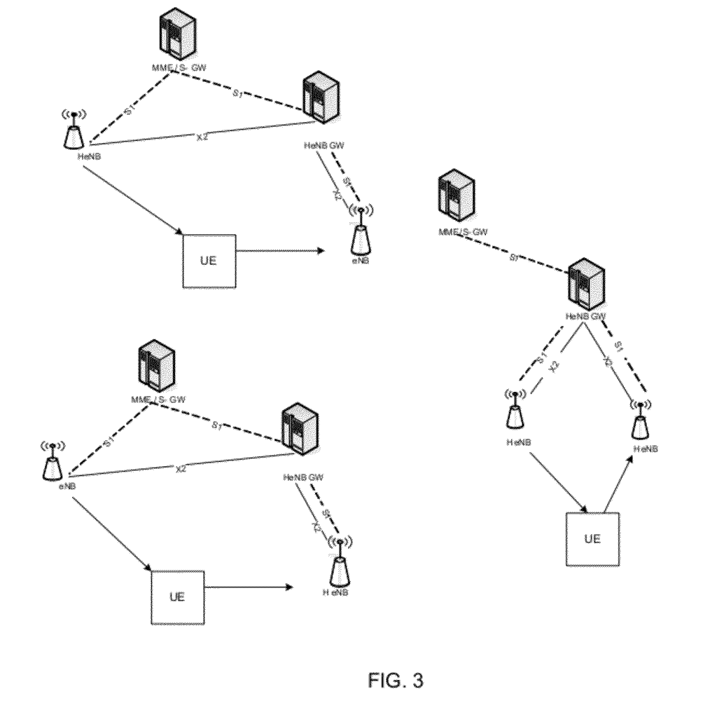

FIG. 3 illustrates a scenario where the HO procedure may be terminated at the HeNB-GW using an X2 interface. Embodiments contemplate that, at the initial context establishment or context modification, the MME may provide the HeNB-GW with the security context including an initial K_{eNB}, the corresponding derived NH value, and/or the associated NCC parameter (e.g., value one). An example of an S1-AP message used for initial context establishment is the INITIAL CONTEXT SETUP REQUEST message. Also, an example of an S1-AP message used for the UE context modification is the CONTEXT MODIFICATION REQUEST message. The HeNB-GW may use the security information provided by the MME, including the (NH, NCC) pair, to initialize the NH derivation chain. Alternatively or additionally, embodiments contemplate that the HeNB-GW may initialize the security keys derivation process (e.g., compute initial KeNB and set NCC to 0). The HeNB-GW can do this on its own, in coordination with MME, or in coordination with other core network nodes such as the HSS (Home Subscriber Server), for example.

At handover (HO), e.g., upon receiving an X2-AP HANDOVER REQUIRED message from the source eNB or HeNB, the HeNB-GW may generates a fresh (NH, NCC) pair and may provide this to the target eNB or HeNB in the X2-AP HANDOVER REQUEST message. Upon receipt of the X2-AP HANDOVER REQUEST message from the HeNB-GW, the target eNB or HeNB may compute the K_{eNB} to be used with the UE by performing a vertical key derivation using the fresh (NH, NCC) pair in the X2-AP HANDOVER REQUEST, the target PCI, and/or the target eNB's or HeNB's EARFCN-DL. The target HeNB or eNB may associate the NCC value received from HeNB-GW with the K_{eNB}. The target HeNB or eNB may include the NCC value from the received (NH, NCC) pair into the HO Command to the UE (perhaps via the HeNB-GW and the source HeNB or eNB using an X2 and/or an S1 interface) and, alternatively or additionally, may remove any existing unused stored (NH, NCC) pairs. By doing so, embodiments contemplate that the HeNB-GW may take the role of the MME with regards to computing new NH and NCC pair values during HO.

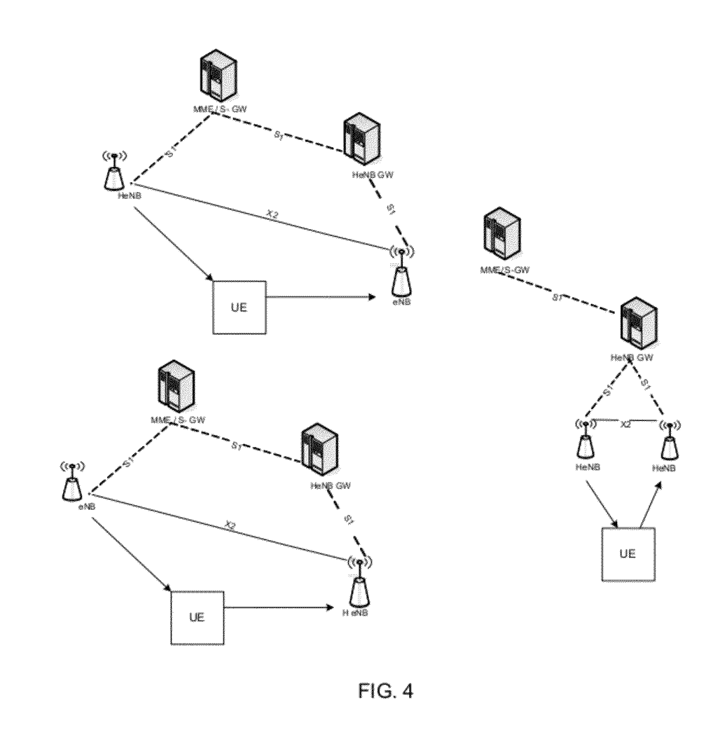

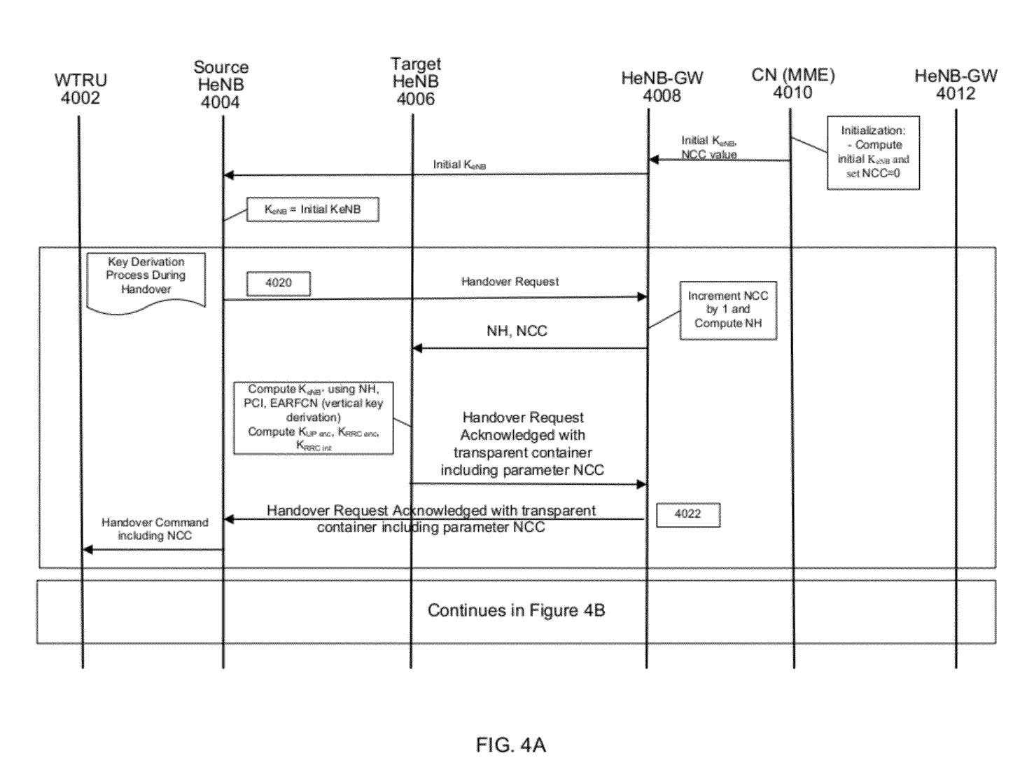

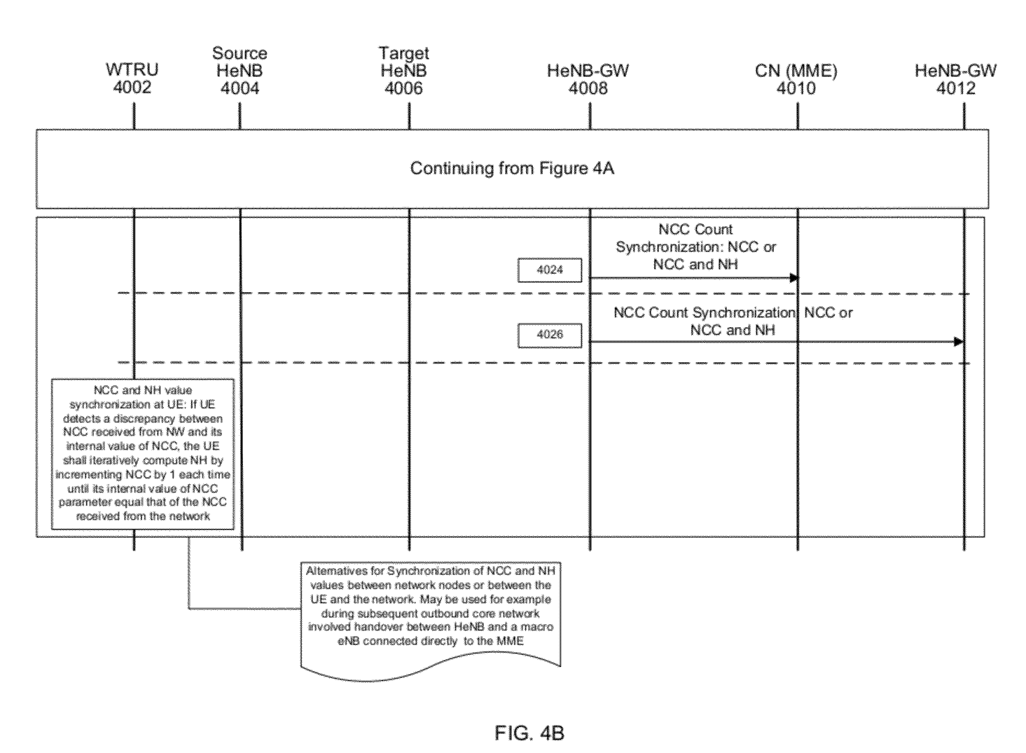

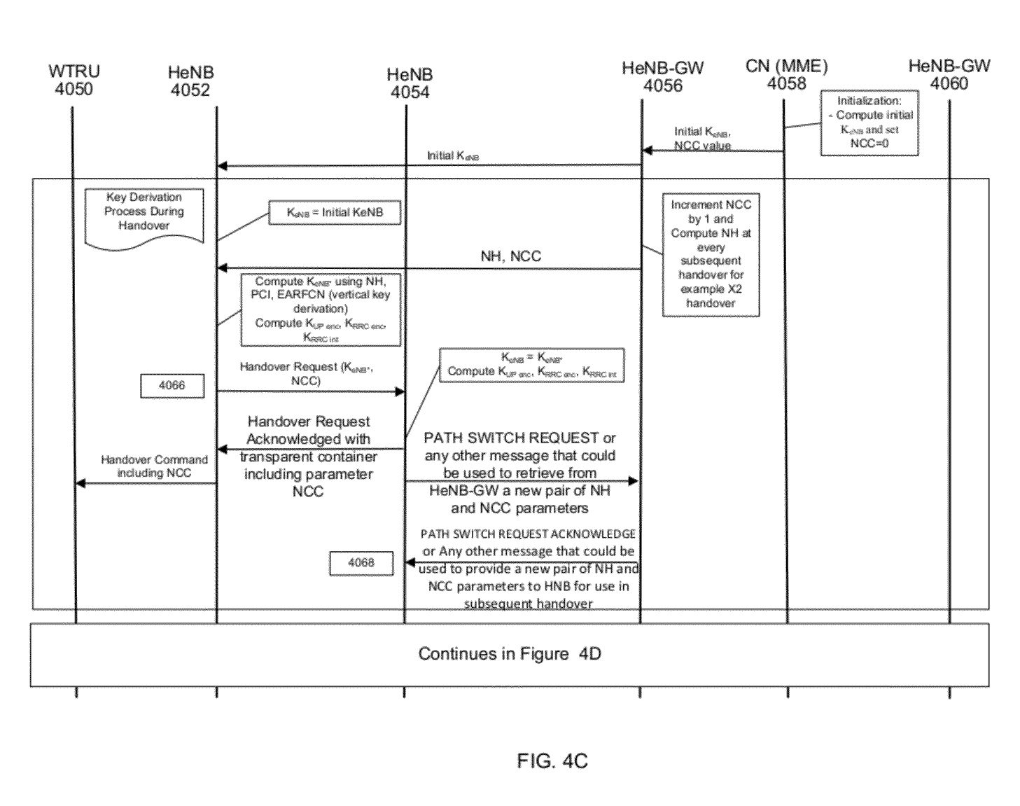

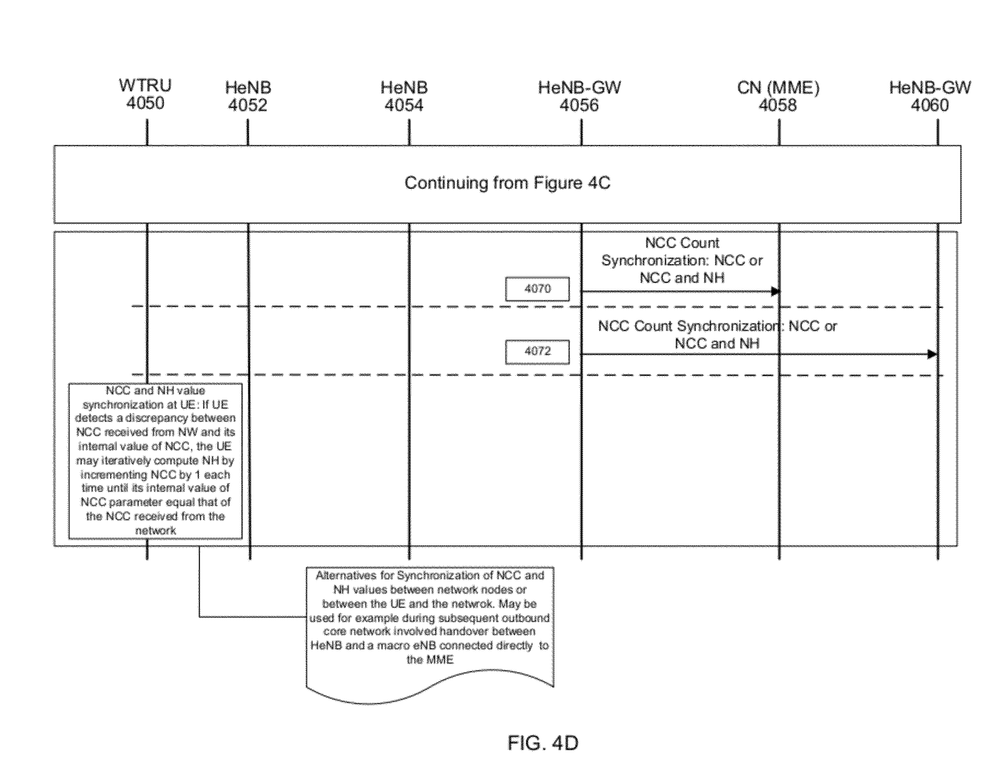

FIG. 4 illustrates a scenario including a direct X2 Interface Handover procedure. Embodiments contemplate that, at the initial context establishment or context modification, the MME may provide the HeNB-GW with the security context including an initial K_{eNB}, the corresponding derived NH value, and/or the associated NCC parameter (e.g., value one). An example of an S1-AP message that may be used for initial context establishment is the INITIAL CONTEXT SETUP REQUEST message. An example of an S1-AP message used for the UE context modification may be the CONTEXT MODIFICATION REQUEST message. The HeNB-GW may use the security information provided by the MME, including the (NH, NCC) pair, to initialize the NH derivation chain. Alternatively or additionally, embodiments contemplate that the HeNB-GW may initialize the security keys derivation process (e.g., compute initial KeNB and set NCC to 0). The HeNB-GW can do this on its own, in coordination with MME, or in coordination with other core network nodes such as the HSS (Home Subscriber Server), for example.

The source eNB or HeNB may perform a vertical key derivation, and in some embodiments may do so in case the source eNB or HeNB may have an unused (NH, NCC) pair. The source eNB or HeNB may first compute K_{eNB*} from target PCI, the target eNB's or HeNB's EARFCN-DL, and/or either from a currently active K_{eNB} in the case of horizontal key derivation or from the NH in the case of vertical key derivation. The source HeNB or eNB may forward the (KeNB*, NCC) pair to the target eNB or HeNB via the X2 interface, for example. The target eNB or HeNB may use the received K_{eNB*} directly as a K_{eNB} to be used with the UE. Alternatively or additionally, the target HeNB or eNB may associate the NCC value received from source HeNB or eNB with the K_{eNB}. The target HeNB or eNB may include the received NCC into the prepared HO Command message, which may be sent back to the source eNB or HeNB in a transparent container via the X2 interface, for example, and may be forwarded to the UE by source eNB or HeNB.

When the target eNB or HeNB has completed the handover signaling with the UE, the target eNB or HeNB may send a S1 PATH SWITCH REQUEST or an X2 PATH SWITCH REQUEST message to the HeNB-GW. Upon reception of the PATH SWITCH REQUEST, embodiments contemplate that the HeNB-GW may increase its locally kept NCC value by one or more and may compute a fresh NH by using a K_{ASME} and/or the HeNB-GW's locally kept NH value. The HeNB-GW may then send the freshly computed (NH, NCC) pair to the target HeNB or eNB in the S1 or X2 PATH SWITCH REQUEST ACKNOWLEDGE message. The target eNB or HeNB may store the received (NH, NCC) pair for one or more further handovers and, alternatively or additionally, may remove other existing unused stored (NH, NCC) pairs, if any.

Because the S1 or X2 path switch message may be transmitted after the radio link handover, the S1 or X2 path switch message may be used to provide keying material for the next handover procedure and target HeNB or eNB, and in some embodiments the S1 or X2 path switch message may only be used to provide keying material for the next handover procedure and target HeNB or eNB. Thus, for example, for X2-handovers, key separation may happen just after two hops because the source HeNB or eNB may know the target HeNB or eNB keys. The target HeNB or eNB may initiate an intra-cell handover to take the fresh NH into use once the fresh NH has been received in the PATH SWITCH REQUEST ACKNOWLEDGE message.

FIG. 4A and FIG. 4B illustrate an exemplary signal flow diagram contemplated by embodiments. In FIGS. 4A and 4B, source HeNB 4004 may have previously received a handover of the WTRU 4002 with information, such as an initial K_{eNB}, provided by the HeNB-GW 4008. Among the illustrated elements, at 4020, source HeNB 4004 may send a handover request to HeNB-GW 4008. After receiving an acknowledgment of the handover request and an NCC parameter from the target HeNB 4006, at 4022, the HeNB-GW 4008 may send an acknowledgment of the handover request and an NCC parameter to the source HeNB 4004. At 4024, the HeNB-GW 4008 may send an NCC count synchronization, which may include the NCC and/or the NH, to the MME 4010. Alternatively or additionally, at 4026, the HeNB-GW 4008 may send the NCC count synchronization, which may include the NCC and/or the NH, to the HeNB-GW 4012.

FIG. 4C and FIG. 4D illustrate another exemplary signal flow diagram contemplated by embodiments. In FIGS. 4C and 4D, HeNB 4052 may have previously received a handover of the WTRU 4050 with information, such as an initial K_{eNB}, provided by the HeNB-GW 4056. Among the illustrated elements, at 4066, HeNB 4052 may send a handover request to HeNB 4054. At 4068, after acknowledging the handover request, the HeNB 4054 may receive a new (or fresh) pair (NH, NCC) that the HeNB 4054 may use in a subsequent handover. At 4070, the HeNB-GW 4056 may send an NCC count synchronization, which may include the NCC and/or the NH, to the MME 4058. Alternatively or additionally, at 4072, the HeNB-GW 4056 may send the NCC count synchronization, which may include the NCC and/or the NH, to the HeNB-GW 4060.

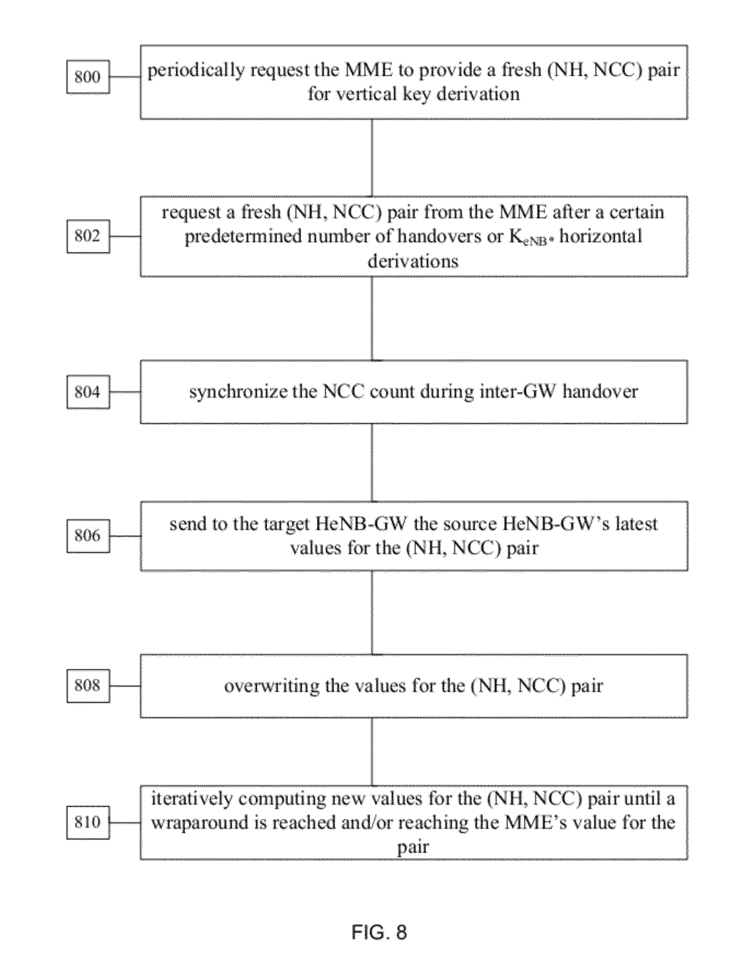

Referring to FIG. 8, alternatively or additionally, embodiments contemplate that the either the target or the source HeNB, (or the HeNB-GW) may, at 800, periodically request the MME to provide a fresh (NH, NCC) pair for vertical key derivation. This may be achieved by defining an S1-AP message, previously not defined, to fetch the fresh parameters. Alternatively, an existing S1-AP message may be used with previously undefined information elements (IEs) that may be defined to request such parameters.

Alternatively or additionally, embodiments contemplate that, at 802, the either the target or the source HeNB, (or the HeNB-GW) may request a fresh (NH, NCC) pair from the MME after a certain, perhaps predetermined, number of handovers or K_{eNB*} horizontal derivations. This may be achieved by defining a S1-AP message, previously not defined, to fetch the fresh parameters. Alternatively, an existing S1-AP message may be used with previously undefined information elements (IEs) that may be defined to request such parameters.

In addition, the embodiments described previously can be used for one or more handovers between a macro eNB and HeNB. Moreover, the embodiments described previously may be used in various combinations. For example, in some embodiments, the handover required message may be sent using an S1-AP message while the handover request message is sent using an X2-AP message.

Alternatively or additionally, embodiments contemplate that, at 804, the HNB-GW and the MME may synchronize their NCC count during inter-GW handover.

Alternatively or additionally, in inter-GW handover, embodiments contemplate that the source HeNB-GW may, at 806, send to the target HeNB-GW its latest values for the (NH, NCC) pair. The target HeNB-GW may use this pair in support of NH chaining for one or more further handovers.

Alternatively or additionally, embodiments contemplate that if one or more parameters are synchronized just during the HO, then it may be possible that the UE and the MME may hold different values for (NHH, NCC). This can happen, for example, if N transparent HOs have occurred, while the MME may have been involved in M handovers, where M may be less than N. In such cases, it may be possible (perhaps even if the HeNB-GW was involved in the security parameter updates) that the MME may have a lower value for the (NH, NCC) pair than that of the UE. In such scenarios, if the MME may be involved in a HO (for example, the handover is not transparent) and if the MME may provide a smaller value for the (NH, NCC) pair (e.g. via the target HeNB, perhaps in the HO command message), then the UE may set its values for the (NH, NCC) pair to match that of the MME (or target eNB or HeNB. Embodiments contemplate that, at 808, this matching may be done by overwriting the values for the (NH, NCC) pair or, at 810, by iteratively computing new values for the (NH, NCC) pair until a wraparound is reached and/or ultimately reaching the MME's value for the pair, for example.

Embodiments contemplate that one or more issues may be encountered with the handling of MME signaling during a transparent HO, such as those HO that are transparent to the CN and/or the MME. For example, embodiments contemplate scenarios during which the MME may send at least one S1-AP message to the source HeNB or eNB during the time that the source HeNB or eNB may be performing signaling to handoff a UE to a target HeNB or eNB. Such scenarios warrant consideration regarding whether the HeNB-GW may directly forward the message to the source HeNB or eNB, buffer the message until the HO is complete, or drop the message.

The handling of MME signaling during the HO may be impacted by HeNB-GW actions if the MME sends S1 AP messages to a source HeNB or eNB during an ongoing HO procedure which may be transparent to the CN/MME. Embodiments contemplate that the HeNB-GW may forward the message to the source HeNB or eNB, and in some embodiments may forward the message to the source HeNB or eNB as long as the HO is not completed. The source node may either respond to the message or may ignore the message. The manner in which the source node may act in regard to the message may depend on whether or not the particular procedure is one that requires a response from the source node to the MME. By way of example, and not limitation, embodiments contemplate that if the HO is not completed yet, the source node may forward this request to the target node as part of the HO signaling or just after the HO is completed but before the communication between the source and target is terminated. Alternatively, the source node may forward the message in the form of an IE that may be included in the messages (S1 or X2) that may be exchanged between the source and target nodes (possibly via the HeNB-GW which may be relaying these messages between the nodes, for example).

Alternatively or additionally, embodiments contemplate that the HeNB-GW may buffer the message until the HO is completed, after which the GW may forward the message to the target HeNB or eNB. The target node may then take the necessary action. For example, the target node may respond or just take the information into account for further processing.

In addition, embodiments contemplate that an HeNB-GW may forward the message to both the source nodes and the target nodes. However, if the HO fails, embodiments contemplate that the source node may act upon the message (e.g., responds or takes the information into account). Alternatively, if the HO succeeds, embodiments contemplate that the source node may ignore the message but the target node may act upon the message (e.g., responds or takes the information into account). Alternatively, the HeNB-GW may inform the source node and/or the target node to act upon the message (e.g., respond or takes the information into account) depending on the success or failure status of the HO, for example.

Also, embodiments contemplate that the HeNB-GW may autonomously fail the newly initiated procedure and may issue an appropriate message to the MME with the relevant cause such as “handover in progress”, for example. Combinations of the features of the aforementioned embodiments are also contemplated.

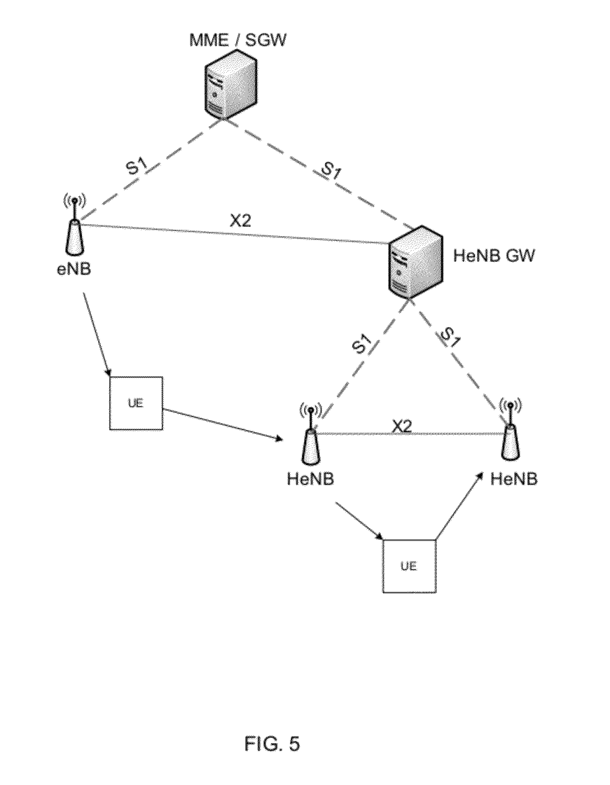

FIG. 5 illustrates contemplated embodiments of an architecture in which handovers may be performed that may be transparent to the Core Network (CN) and/or the MME. In FIG. 5, by way of example, and not limitation, HeNBs may be connected with each other via an X2 interface and the HeNBs may be connected with an HeNB-GW. Also, an HeNB may be connected with an eNB via an X2 interface, for example. Some or all of the embodiments described herein in relation with key derivation and transparent (e.g., non-core network involved) handover procedures may also apply to FIG. 5.

Embodiments contemplate that in handovers that are transparent to the CN (and/or the MME), the Target HeNB (or eNB) may not be able to accommodate a sub-set of the UE's bearers as in the source HeNB (or eNB). It may be possible that the target HeNB (or eNB) cannot provide the same resources (e.g., radio bearer resources or S1 resources, for example) for the UE. As such, some of the bearers that the UE may have had in the source HeNB (or eNB) may be dropped by the target HeNB (or eNB), for example due to high load conditions or if the HeNB (or eNB) is a hybrid/open mode cell where non-members might still be accepted but with a lower service rate. In such examples, the MME might not know that at least one bearer (and possibly more than one bearer) was dropped for the UE in question since the HO is transparent. Thus, embodiments contemplate one or more mechanisms that may provide some form of EPS (Evolved Packet System) bearer context synchronization between the UE and the MME since both entities may maintain EPS bearer contexts that have one-to-one mapping with radio bearers at the access stratum level.

Embodiments contemplate that a target HeNB or eNB may trigger a context modification procedure with the MME to inform the MME about the release or modification of certain bearers after the HO is completed (or perhaps before the HO). Embodiments contemplate that one or more cause values not indicating HO may be used where one or more cause values may exist, or in some embodiments one or more cause values, hereunto undefined, may be defined. This can also be sent by the HeNB-GW, for example, if the HeNB informs the GW as such. Alternatively, the modification of the bearers may be performed by the source HeNB or eNB before the HO, for example after the source node receives an indication that not all bearers may be accommodated in the target node. Embodiments contemplate that the indication may be sent by either the GW and/or the target node.

Embodiments also contemplate that the handover may be performed even if some bearers are modified or released and the UE is normally informed via the RRC signaling (for example via a RRCConnectionReconfiguration message) about any bearers that may have been modified or released. For example, if the UE is informed about the release of certain bearers, the access stratum (AS) may inform the non-access stratum (NAS) about these bearers and the corresponding identities. Embodiments contemplate that the UE might not be aware that the HO is transparent to the MME. The UE may be configured to send a tracking area update request message in which the UE may indicate the status of the EPS bearer contexts based on triggers from the Assess Stratum. An example of an EPS bearer status could be “deactivated.” Embodiments also contemplate that the MME may be synchronized with the UE with regards to the EPS bearer context, and perhaps at the same time the MME may be unaware of the HO between the HeNBs.

Embodiments contemplate that this may be applied to all HOs or perhaps just to HO involving HeNBs or macro eNBs that are working as open mode closed subscriber group (CSG) cells.

The proposals in this document can be applied in any combination and can also apply to 3G HNB e.g. instead of sending a TAU (Tracking Area Update) as proposed above, the UE can send a RAU (Routing Area Update) to update the SGSN with the PDP (Packet Data Protocol) contexts in the UE.

Embodiments also contemplate that an indication as to whether a HO is transparent or not may be indicated to one or more nodes in the network, for example UE, and/or an HeNB or eNB, among others. For example, if the GW may be configured to perform HOs that are transparent to the MME, the GW may inform the UE, the HeNB, or the eNB that a particular (or one or more) HO is transparent to the CN/MME. An indication to this effect may be included in mobility messages that may be exchanged between these nodes e.g. over S1, X2 and RRC in the case of informing the UE. The recipients of such indication may take certain actions e.g. the target HeNB or eNB may accept a HO even though not all RABs may be accommodated as requested by the source. When the target node may be informed that the HO is transparent, then the target HeNB or eNB may inform the MME (using S1 AP messaging after the HO is completed or before, for example) about the release of certain bearers. Embodiments also contemplate that the MME may initiate a UE Context Modification Procedure towards the HeNB.

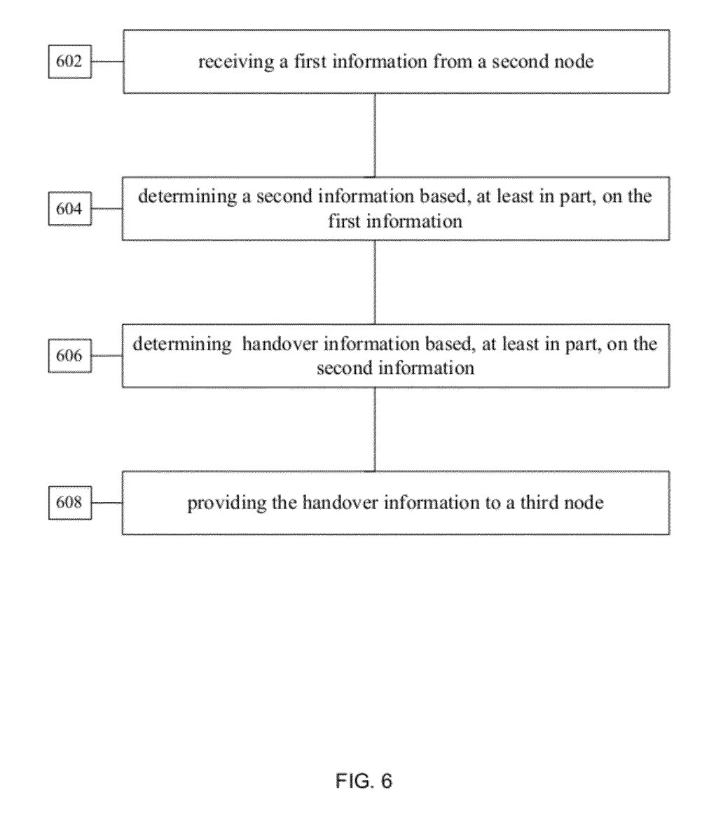

In light of the foregoing description, and referring to FIG. 6, contemplated embodiments may be performed by a first node, where the first node may be in communication with a communication network. At 602, embodiments contemplate receiving a first information from a second node. Embodiments contemplate that the second node may be in communication with the communication network. At 604, embodiments contemplate determining a second information based, at least in part, on the first information. And embodiments contemplate, at 606, determining handover information based, at least in part, on the second information. Embodiments further contemplate that the first information may be at least one of a next hop (NH) parameter or Next hop Chaining Counter (NCC) parameter and that the second node may be a home evolved node-B gateway (HeNB-GW). At 608, contemplated embodiments may include providing the handover information to a third node.

Further, embodiments contemplate that the third node may be in communication with the communication network and that the third node may be at least one of a home evolved node-B gateway (HeNB-GW), an evolved node-B (eNB), a home evolved node-B (HeNB), or a user equipment (UE). Alternatively or additionally, embodiments contemplate that the first node may be designated to receive the handover and the first node may be at least one of an evolved node-B (eNB) or a home evolved node-B (HeNB). Also, embodiments contemplate that the second information may be a K_{eNB}, and that, alternatively or additionally, the second information may be derived, at least in part, by vertical key derivation. Embodiments also contemplate that that the handover information may include at least one of a K_{eNB} or the Next hop Chaining Counter (NCC) parameter. In addition, embodiments contemplate that the first information may be received via at least one of an X2 interface or an S1 interface.

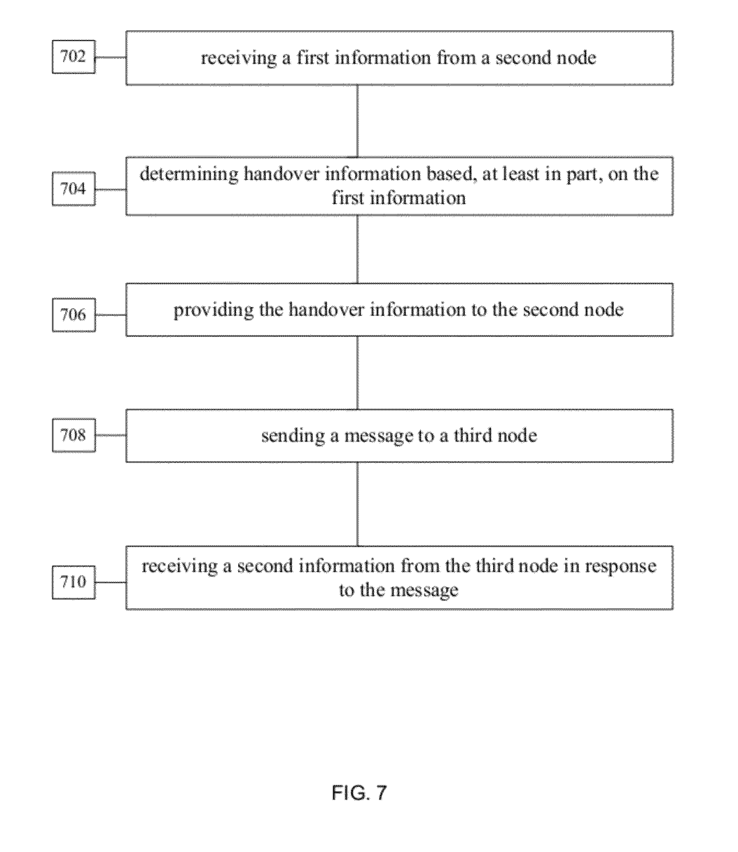

Referring to FIG. 7, alternative or additional contemplated embodiments may be performed by a first node, where the first node may be in communication with a communication network. At 702, embodiments contemplate receiving a first information from a second node, where the second node may be in communication with the communication network. At 704, embodiments further contemplate determining handover information based, at least in part, on the first information, and, at 706, providing the handover information to the second node. At 708, embodiments contemplate sending a message to a third node, and, at 710, receiving a second information from the third node in response to the message.

Embodiments contemplate that the first node may be designated to receive the handover and that the first node may be at least one of an evolved node-B (eNB) or a home evolved node-B (HeNB). Alternatively or additionally, embodiments contemplate that the second node may be designated to initiate the handover and that the second node may be at least one of an evolved node-B (eNB) or a home evolved node-B (HeNB). Embodiments also contemplate that the first information may be received via an X2 interface and/or the handover information may be provided via the X2 interface. Alternatively or additionally, the third node may be a home evolved Node-B gateway (HeNB-GW), and/or the first node may be at least one of an evolved node-B (eNB) or a home evolved node-B (HeNB).

Embodiments also contemplate one or more devices, or nodes, such as but not limited to a home evolved node-B gateway (HeNB-GW), an evolved node-B (eNB), a home evolved node-B (HeNB), or a user equipment (UE), that may be configured to perform the described embodiments.

While the various embodiments have been described in connection with the various figures, it is to be understood that other similar embodiments may be used or modifications and additions may be made to the described embodiment for performing the same function of the various embodiments without deviating there from. Therefore, the embodiments should not be limited to any single embodiment, but rather should be construed in breadth and scope in accordance with the appended claims.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method performed by a first node, the first node in communication with a communication network, and the method comprising:
receiving a first information from a second node, the second node in communication with the communication network;
determining a second information based, at least in part, on the first information; and
determining handover information based, at least in part, on the second information.

2. The method of claim 1, wherein the first information is at least one of a next hop (NH) parameter or Next hop Chaining Counter (NCC) parameter.

3. The method of claim 1, wherein the second node is a home evolved node-B gateway (HeNB-GW).

4. The method of claim 1, wherein the method further comprises providing the handover information to a third node, the third node in communication with the communication network.

5. The method of claim 4, wherein the third node is at least one of a home evolved node-B gateway (HeNB-GW), an evolved node-B (eNB), a home evolved node-B (HeNB), or a user equipment (UE).

6. The method of claim 1, wherein the first node is designated to receive the handover and the first node is at least one of an evolved node-B (eNB) or a home evolved node-B (HeNB).

7. The method of claim 1, wherein the second information is a K_{eNB}.

8. The method of claim 7, wherein the second information is derived, at least in part, by vertical key derivation.

9. The method of claim 2, wherein the handover information includes the Next hop Chaining Counter (NCC) parameter.

10. The method of claim 1, wherein the first information is received via at least one of an X2 interface or an S1 interface.

11. A first node, the first node in communication with a communication network, and the first node configured, at least in part, to:
receive a first information from a second node, the second node in communication with the communication network;
determine a second information based, at least in part, on the first information; and
determine handover information based, at least in part, on the second information.

12. The first node of claim 11, wherein the first information is at least one of a next hop (NH) parameter or Next hop Chaining Counter (NCC) parameter.

13. The first node of claim 11, wherein the second node is a home evolved node-B gateway (HeNB-GW).

14. The first node of claim 11, wherein the first node is designated to receive the handover and the first node is at least one of an evolved node-B (eNB) or a home evolved node-B (HeNB), and the first node is further configured to provide the handover information to a third node, the third node in communication with the communication network.

15. The first node of claim 14, wherein the third node is at least one of a home evolved node-B gateway (HeNB-GW), an evolved node-B (eNB), a home evolved node-B (HeNB), or a user equipment (UE).

16. The first node of claim 11, wherein the first information is received via at least one of an X2 interface or an S1 interface.

17. A method performed by a first node, the first node in communication with a communication network, and the method comprising:
receiving a first information from a second node, the second node in communication with the communication network;
determining handover information based, at least in part, on the first information; and
providing the handover information to the second node.

18. The method of claim 17, further comprising:
sending a message to a third node; and
receiving a second information from the third node in response to the message, wherein the first node is designated to receive the handover and the first node is at least one of an evolved node-B (eNB) or a home evolved node-B (HeNB).

19. The method of claim 17, wherein the first information is received via an X2 interface and the handover information is provided via the X2 interface.

20. The method of claim 18, wherein the third node is a home evolved Node-B gateway (HeNB-GW) and the first node is at least one of an evolved node-B (eNB) or a home evolved node-B (HeNB).
